(19) United States
(12) Patent Application Publication
(10) Pub. No.: US 2018/0352430 A1
(43) Pub. Date: Dec. 6, 2018

(54) SYSTEMS AND METHODS FOR CREATING ELECTRONIC ACCESS ACCOUNTS

(71) Applicant: ATLASSIAN PTY LTD, SYDNEY (AU)

(72) Inventors: Sherif Mansour, Peakhurst (AU); Sidney Gee-Lake Shek, Carlingford (AU); Ashwin Srinivasan, West Pennant Hills (AU)

(73) Assignee: ATLASSIAN PTY LTD, SYDNEY (AU)

(21) Appl. No.: 15/608,787

(22) Filed: May 30, 2017

(51) Int. Cl. H04W 12/06; H04W 48/14; G06F 21/31; H04L 29/06

(52) U.S. Cl. CPC H04W 12/06; H04W 48/14; H04L 63/10; H04L 63/0823; G06F 21/31

(57) ABSTRACT

Systems and methods for automatically creating electronic access accounts at a service provider system are disclosed. The method comprises receiving from a client device, an account creation request for creating service provider accounts at the service provider system; responsive to receiving the account creation request: identifying a group associated with the account creation request; generating and communicating an account information request to an identity platform independent of the service provider system; receiving from the identity platform, an account information response identifying a plurality of identity platform accounts maintained by the identity platform and associated with the group identifier; and for a given identity platform account identified in the account information response: obtaining account details for the given identity platform account and creating a local service provider account corresponding to the given identity platform account using the obtained account details in respect of the given identity platform account.

### TECHNICAL FIELD

Aspects of the present disclosure are directed to systems and methods for creating electronic access accounts.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

With the increasing use of distributed web services and cloud computing, a large number of online services and applications are available to users these days. Users are typically required to create electronic access accounts or register with these services/applications before they can begin using them. Account creation usually entails generating login credentials, filling lengthy personal detail forms, and verifying personal details.

In addition to being annoying, this process is usually time consuming, increases user screen time and effort, and increases network traffic and bandwidth consumption.

Accordingly, it would be useful to find a better way of creating electronic access accounts at online services and applications.

### SUMMARY

The appended claims may serve as a summary of the invention.

### BRIEF DESCRIPTION OF THE DRAWINGS

In the drawings:

FIG. 1 is a block diagram of a networked environment according to aspects of the present disclosure.

FIG. 2 is a block diagram of a computing system with which various embodiments of the present disclosure may be implemented.

FIG. 3 is a high-level flowchart illustrating a method for registering multiple users with a service provider according to some aspects of the present disclosure.

FIG. 4 is a message-passing diagram illustrating an example method for registering multiple users with a service provider according to a pull embodiment.

FIG. 5 is a flowchart illustrating the method steps performed by an identity platform to register a group of users with a service provider according to the pull embodiment.

FIG. 6 is a flowchart illustrating the method steps performed by a service provider to register a group of users according to the pull embodiment.

FIG. 7 is a message-passing diagram illustrating an example method for registering multiple users with a service provider according to a push embodiment.

FIG. 8 is a flowchart illustrating the method steps performed by an identity platform to register a group of users with a service provider according to the push embodiment.

FIG. 9 is a flowchart illustrating the method steps performed by a service provider to register a group of users according to the push embodiment.

FIG. 10 is a flowchart illustrating a method for updating a service provider database.

While the invention is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the spirit and scope of the present invention as defined by the appended claims.

### DETAILED DESCRIPTION

In the following description, for the purposes of explanation, numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

Throughout this disclosure the terms “registration” and “account creation” are used interchangeably. Both these terms refer to the process of retrieving details about a user or a group and creating a local account/record for that user or group based on the retrieved user or group details. Moreover, the term “local account” in respect to a given system refers to an account that is locally created and maintained at that given system (as opposed to an account created/maintained by another system). The term “electronic access account” is used interchangeably with “access account” or simply “account” and refers to an electronic account that can be used by a user to access a given system (e.g. via login credentials).

A user group (that represents a collection of users with similar duties or interests) is typically created to provide the same access rights to the users in that group. For example, if an organization wishes to assign full access to a file folder for its marketing department, the organization can create a group that includes the users in the marketing department and then assign that group full access to the folder.

Frequently, members of a group (from one particular platform) may need to use a new software application (hosted on a different platform)—i.e., the finance department of an organization may require employees to use a new collaborative spreadsheet tool, a group of rock climbing aficionados on Facebook™ may wish to become members of a new outdoor climbing meet-up application, or a family group on WhatsApp™ may wish to use a new collaborative chat application. Typically, to start using the new application, each member of the group has to individually create an account with the new application (e.g., by visiting a website and providing their personal information and/or credentials).

In some cases, a group member becomes aware of the new application, informs other group members, and requests them to create accounts with the software application. In other cases, a group member may create an account with the new application and request it to invite other group members to register. However, in both these cases, the first group member may inadvertently forget to inform/invite some group members.

Aspects of the present disclosure are directed to methods and systems for automatically creating electronic access accounts for a plurality of users at a first service provider (i.e., an entity providing an application/service). Generally speaking, in some embodiments, a user that is part of a pre-existing team/group at a different service provider (referred to as an identity platform herein) requests the first service provider to create local electronic access accounts for members of the user's group on behalf of the group. The first service provider subsequently requests the identity platform (that stores identification information in respect of the group members) to provide information about the group (such as member account details). Using this, the first service provider can create local accounts for group members, and notify them and/or the identity platform once the accounts have been created.

In certain other embodiments, a group member requests the service provider that the member has a pre-existing team/group account with (i.e., the identity platform) to register members of the corresponding team/group with a particular service provider. In this case, the identity platform pushes the relevant information about group members to the service provider and requests the service provider to create local accounts for the group members. Once local accounts are created, the service provider may notify the identity platform, which in turn may inform the group that accounts have been created at the service provider.

Environment Overview

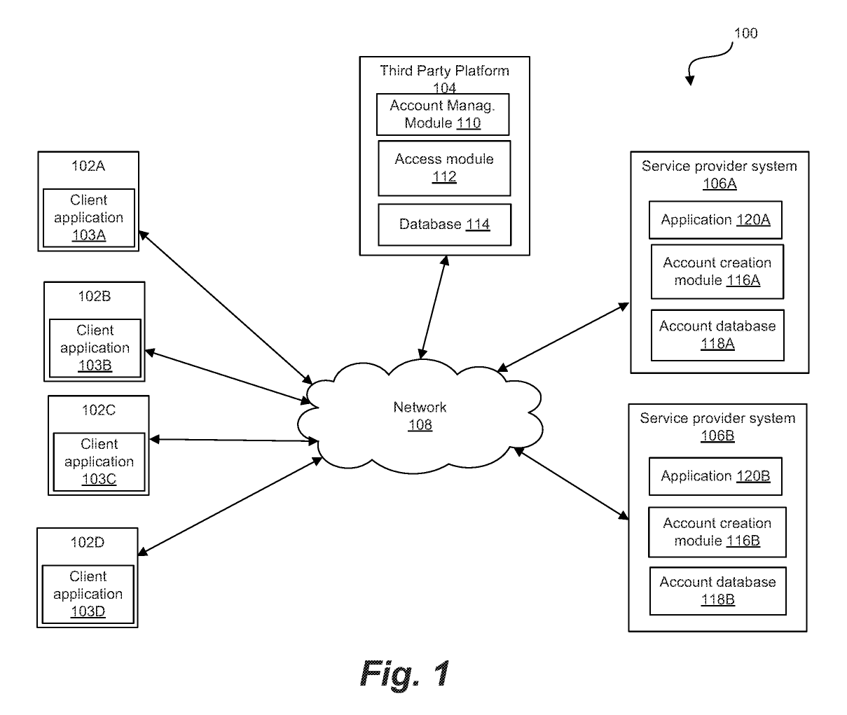

FIG. 1 illustrates an environment 100 in which aspects of the present disclosure are implemented. Specifically, FIG. 1 illustrates the systems involved in creating local accounts for a group of users at a service provider. The systems include client devices (e.g., client devices 102A, 102B, 102C, and 102D, collectively referred to as client devices 102), an identity platform 104, and service provider systems (such as service provider systems 106A and 106B, collectively referred to as service provider systems 106 or service providers 106 in this disclosure). The client devices 102, identity platform 104, and service providers 106 communicate with each other over one or more communication networks 108.

Generally speaking, the client devices 102, identity platform 104, and service providers 106 communicate with each other to create local accounts for a group of users at a particular service provider. The client devices 102 generate account creation requests. The service providers 106 act on these requests and create local accounts for group members, and the identity platform 104 provides the data required by the service provider to create local accounts.

The client device 102 may be any suitable device, for example a mobile device (e.g. a tablet or mobile phone), a portable device (such as laptop computer), or any other computing device (e.g. a desktop computer).

As illustrated in FIG. 1, each client device 102 may include one or more client (software) applications (e.g., client applications 103A, 103B, 103C, and 103D) that are configured to access one or more software applications made available by the identity platform 104 and/or the service providers 106. The client application 103 includes instructions and data stored in the memory (e.g. non-transient compute readable media) of the client device 102 on which the application is installed/run. These instructions are executed by a processor of the client device 102 to perform various functions as described herein. By way of example, some functions performed by the client application 103 include communicating with applications hosted by the identity platform 104 and/or the service providers 106, rendering user interfaces based on instructions received from those applications, and receiving inputs from users allowing them to interact with the applications hosted by the identity platform and service providers.

The client application 103 may be implemented in various ways. For example, the client application 103 may be a web browser application (such as, for example, Chrome, Safari, Internet Explorer, Opera) which accesses the applications hosted by the identity platform 104 and the service providers 106 via appropriate uniform resource locators (URL) and communicates with these systems via general world-wide-web protocols (e.g. HTTP, HTTPS, FTP). In this case the web browser application is configured to request, render and display user interfaces that conform to a markup language such as HTML, XML or extensions, and may be capable of internally executing browser-executable code such as JAVASCRIPT, or other forms of code. Alternatively, the client application 103 may be a specific application programmed to communicate with the identity platform 104 and/or the service providers 106 using defined application programming interface (API) calls.

In general, the identity platform 104 stores and maintains user and group data and shares this data with a service provider 106 as and when required. User data refers to personal information about a user, such as a user's name, age, gender, country, username and password. Group data refers to information about a group to which multiple users are assigned. By way of example, group data may include a group name, a list of group members, and a list of access rights assigned to the group.

In order to maintain and share user and group data, the identity platform 104 includes an account management module 110, an access module 112, and a database 114 as illustrated in FIG. 1.

The account management module 110 is configured to create, edit and manage user and group accounts for storing user and group data. In particular it is configured to receive requests to create new user or group accounts, edit or update existing accounts and delete accounts when required.

The access module 112 is configured to authenticate users and service providers 106. Users are authenticated, for example, when they access an application hosted by the identity platform 104 or a service provider (e.g., 106A). Service providers may be authenticated when they wish to access user and/or group data. Once a service provider is authenticated, the access module 112 communicates with the service provider to, e.g., forward user/group data and receive account status information.

The database 114 stores user data, group data, and information in respect of service providers. User data may be stored in the form of access accounts/records. In each access account, a variety of information may be recorded and stored for a given user against a unique user ID. For example, for a given user ID, such information may include authentication credentials (e.g., username, password, secret question and answer) and personal data (e.g., email address, name, gender, age, country, etc.). It will be appreciated that some of this information may be received from the client application 103 when a user registers with the identity platform 104 (e.g., by providing personal information to create the access account) and other information may be updated as and when the user engages with the identity platform 104.

Examples of data structures for storing user data are illustrated in Tables A and B. Although tables are used to illustrate these data structures, the relevant information need not be stored in tables and could be stored in any other appropriate format.

TABLE A
User Authentication Data

| User | | |
|---|---|---|
| ID | Username | Password Hash |
| . . . | | |
| 123762 | Alfie99 | 110edf2294fb8bf4 |
| 123767 | Charlie1983 | 8fda7e1f0b56572f |
| 123772 | EchoD | 2fca9b003de39778 |
| . . . | . . . | . . . |

TABLE B
User Personal Data

| User ID | Name | Email address | Age | Gender | Country |
|---|---|---|---|---|---|
| . . . | . . . | . . . | . . . | . . . | . . . |
| 123762 | Alfred Phangiso | Alfie99@gmail.com | 21 | M | United States |
| 123767 | David | BravoD@aol.com | 23 | M | United |
| | Bravo | | | | Kingdom |
| 123772 | Clara | Duclkin78@gmail.com | 32 | F | United States |
| | Ducklin | | | | |
| . . . | . . . | . . . | . . . | . . . | . . . |

In the above example tables, each access account/record stores:
a unique user ID
a username
an encrypted password
name
email address
age
gender
country

It will be appreciated that in certain embodiments, tables A and B may be linked (e.g., a relational database) whereas in other embodiments, they may be stored separately.

The database 114 also stores group data in the form of group records/accounts. A variety of information may be stored for a given group record for a given group against a unique group ID. For example, for a given group ID, the database 114 may store information such as the name of the group, user IDs of users that are members of the group, and group access permissions. It will be appreciated that a group record may be added to the group data structure with a unique group ID when a group is created. The information in a group record may be updated from time to time, for example when members are added to or removed from the group or permissions are updated.

Tables C and D below show example data structures for storing this information.

TABLE C
Group Data

| Group | Group | |
|---|---|---|
| ID | name | Permissions |
| . . . | . . . | . . . |
| 8623 | Red | Full access: workshare/teamRed |
| 8630 | Yellow | Full access: |
| | | E:/work/marketing/folder |
| 8633 | Green | Full access: Hipchat/teamgreen |
| . . . | . . . | . . . |

TABLE D
Group Member Data

| Record | Group | Members |
|---|---|---|
| ID | ID | (User IDs) |
| . . . | . . . | . . . |
| 101 | 8623 | 123762 |
| 102 | 8623 | 384629 |
| 103 | 8623 | 378463 |
| 104 | 8465 | 984329 |
| 105 | 8465 | 894739 |

Specifically, in the example table C, for a given unique group ID, the database 114 stores:
Name of the group
User IDs of users that are part of the group
Access permissions assigned to each member of a group.

In the example table D, for a unique record ID, the database 114 stores:
The group ID
The user ID of a group member.

As new members are added to a group, new records are created in table D, where each new record stores the user ID of a group member against a group ID.

As described previously, in addition to information about users and groups, the database 114 also stores information about service providers 106 that have registered with the identity platform 104. This registration may be similar to that performed by users—i.e., a service provider may provide authentication credentials (a service provider ID and password) when the service provider first registers with the identity platform 104. Using this information, the identity platform 104 may create a record for the service provider. In some instances, the record for a given service provider may include a service provider ID, a password, a name, and a URL. Table E below shows an example of a data structure for storing service provider data.

TABLE E
Service Provider Data

| Service | Password | Service provider | |
|---|---|---|---|
| Provider ID | hash | name | Redirect URL |
| . . . | | . . . | . . . |
| 384729 | R89ewfhde | SpreadSheets | Spreadsheets.com.au |
| 758766 | Jkhe7df6sd | ChatApp | www.chatapp.com |
| 783643 | F78sdfhsdj | Photobomb | www.photbomb.com |
| 783649 | C89fdfkejr | Helpdesk | www.helpdesk.com |
| . . . | . . . | . . . | |

In this example, for a given unique service provider ID, the database 114 stores:
An encrypted password
A service provider name
Redirect URL (e.g., to redirect a URL to the service provider 106)

Furthermore, for each service provider, the identity platform 104 maintains a list of users registered with the service provider, the access permissions granted to the service provider for each of those users, and in some cases a list of group accounts registered with the service provider. Tables F and G show examples of data structures for storing information pertinent to a particular service provider.

TABLE F
Example service provider user data

| | Service | | | |
|---|---|---|---|---|
| Record | provider | User | | |
| ID | ID | ID | Permissions | Access Identifier |
| . . . | . . . | . . . | . . . | . . . |
| 05 | 384729 | 123762 | User data | 3jkdsf389472389dl33d |
| | | | and group | |
| | | | data | |
| 06 | 384729 | 374893 | User data | 38dhskjhd38947kh89e |
| | | | and group | |
| | | | data | |
| 07 | 384729 | 249873 | User data | 763jddkh83472kjs834 |
| | | | and group | |
| | | | data | |
| 08 | 783644 | 347324 | User data | 839fhdjkfh8954jksdh3 |
| . . . | . . . | . . . | . . . | . . . |

TABLE G
Example service provider group data

| | Service | |
|---|---|---|
| Record | provider | Group |
| ID | ID | ID |
| . . . | . . . | . . . |
| 3205 | 384729 | 8623 |
| 3206 | 384729 | 8630 |
| 3207 | 384729 | 8633 |
| 3208 | 783644 | 8623 |
| . . . | . . . | . . . |

In table F, for a given record ID, the database 114 stores:
a service provider ID
a user ID of a user that has a local account with the service provider
permissions (i.e., data that the service provider is authorized to access) for each user,
access identifier (a unique token, key or code assigned to a service provider for a particular user). In certain embodiments, the access identifier is used by the service provider each time it wishes to communicate with the identity platform 104 for accessing user/group data.

In the example table G, for each record ID, the database 114 stores:
a service provider ID
a group ID of a group that has a local account with the corresponding service provider.

It will be appreciated that the information depicted in the example tables A-G is merely representative and the data structures may include additional, fewer, or alternative fields without departing from the scope of the present disclosure.

The user, group, and service provider data structures can be managed and stored in a single memory device or in multiple memory devices without departing from the scope of the present disclosure. Furthermore, the database 114 may include a single data structure for storing user, group and service provider data or multiple interrelated data structures.

In certain embodiments, the identity platform 104 is part of a trusted service provider (also referred to as an identity provider) that in addition to authenticating users for third parties, hosts one or more applications/services that users and groups have accounts with. In one example, the identity platform 104 may be managed by Atlassian, Inc., which also hosts applications such as Confluence™, HipChat™, Bitbucket™, and Jira™. Alternatively, the identity platform 104 is a standalone system that is configured to manage user identities, but not provide any other services/applications.

Each service provider 106 is a system entity that hosts one or more software applications (e.g., applications 120A and 120B). A user may access an application hosted by a service provider as a guest (no personalized service) or after creating an access account (allowing the service provider to offer customized content to the user). In some cases, a service provider 106 may allow users to create accounts using traditional methods (i.e., filing an online form with user information and creating a username/password to access the account). Alternatively, it may authenticate users through the identity platform (i.e., by using the credentials (i.e., username and password) created for the identity platform 104). In these cases, the service provider 106 is also configured to automatically create and/or update access accounts upon receiving information from the identity platform 104 and notify users and the identity platform of the creation/update.

In order to create and manage access accounts, each service provider 106 includes an account creation module 116 and an account database 118. The account creation module 116 is configured to communicate with client devices 102 and the identity platform 104 to receive user and group data and notify client devices 102 and/or the identity platform 104 of any changes in user/group accounts. Moreover, the account creation module 116 is configured to create and manage local access accounts based on the received user and group data.

The account database 118 stores information about local access accounts. A variety of information may be recorded and stored for a given user against a unique user ID. Particularly, the account database 118 may store user information accessed from the identity platform 104. Accordingly, for a given user ID, such information may include the corresponding user data managed by the identity platform 104.

An example data structure for storing user information is illustrated in Table H. Although a table is used to illustrate this data structure, the relevant information need not be stored in a table and could be stored in any other appropriate format

TABLE H
Access account Data

| User | | | | | | |
|---|---|---|---|---|---|---|
| ID | Name | Email address | Age | Gender | . . . | Access identifier |
| . . . | . . . | . . . | . . . | . . . | . . . | |
| 123762 | Alfred | Alfie99@gmail.com | 21 | M | . . . | 3jkdsf389472389d133d |
| | Phangiso | | | | | |
| 123767 | David | BravoD@aol.com | 23 | M | . . . | 38dhskjhd38947kh89e |
| | Bravo | | | | | |
| 123772 | Clara | Duclkin78@gmail.com | 32 | F | . . . | 763jddkh83472kjs834 |
| | Ducklin | | | | | |
| . . . | . . . | . . . | . . . | . . . | . . . | . . . |

When a new account is created, the account creation module may add a new record in the access account data structure and add relevant account information. In the above example table, for each unique user ID (which may be the same as the user ID on the identity platform 104), the account database 118 stores:
Name
Email address
Age
Gender
Access identifier (this is the same identifier assigned to the service provider to communicate with the identity platform 104 for accessing data in respect to the user)

It will be appreciated that all the access account information need not be stored at one time. Some information may be updated at a later stage. For example, in some cases, the access identifier field for a given user ID may be updated when a service provider first requests access to user data for that user ID.

If the service provider 106 hosts a collaborative software application, which supports creation of groups for collaboratively working on projects, the account database 118 also includes a data structure storing local group information. The local group information may include multiple fields. By way of example, for a given user ID, such information may include group name, group avatar, members, group preferences, etc.

Example data structures for storing group information are illustrated in Tables I and J

TABLE I
Group Account Data

| Group | Group | | |
|---|---|---|---|
| ID | Name | Preferences | Avatar |
| . . . | . . . | . . . | . . . |
| 8623 | Red | Preference X | <url> |
| 8630 | Yellow | Preferences | <url> |
| | | X, Y and Z | |
| 8633 | Green | Preferences | <url> |
| | | A, E, F | |
| . . . | . . . | . . . | . . . |

TABLE J
Group Member Data

| Record | Group | |
|---|---|---|
| ID | ID | User ID |
| . . . | . . . | . . . |
| 391 | 8623 | 123762 |
| 392 | 8623 | 837430 |
| 393 | 8623 | 345383 |
| . . . | . . . | . . . |

When the service provider 106 receives a request to create accounts for a new group, the account creation module 116 may add a new record in the group account data structure and group member data. In the above example table I, for each unique group ID (which may be the same as the group ID on the identity platform 104), the account database 118 stores:
Group name (may be same as the group name on the identity platform 104)
Preferences (local preferences associated with the group)
Avatar (a group icon or figure)
   And in example table J, for each unique record ID, the account database 118 stores:
A group ID and
A user ID of a user that is a member of the corresponding group.

As illustrated in FIG. 1, communications between the client devices 102, the identity platform 104 and the service providers 106 are via the communications network 108. For example, the client devices 102, identity platform 104 and service providers 106 may communicate with each other through a local area network (LAN) or a public network (e.g., the Internet). Furthermore, the client devices 102 and service providers 106 may communicate with the identity platform 104 over open web protocols such as (HTTPS, REST, and JWT).

It will be appreciated that although only four client devices (102A, 102B, 102C and 102D) and two service providers 106 have been illustrated, in normal operation, many more client devices 102 and service providers 106 may be connected to the identity platform through the network 108. Furthermore, although each service provider 106 in FIG. 1 is illustrated with a single hosted application 120A and 120B, in actual implementation, a service provider may host more than one application and may create a single user/group account for the different hosted applications or individual user and/or group accounts for each hosted application.

### Hardware Overview

The operations/techniques described herein are implemented by one or more special-purpose computing systems or devices. For example, in environment 100: the identity platform 104 may be provided by one or more computer systems; each client device 102 is a computer system; and each of the Service providers 106 are provided by one or more computing systems.

The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hardwired logic, ASICs, or FPGAs with custom programming to accomplish the techniques. The special purpose computing devices may be desktop computer systems, portable computer systems, handheld devices, networking devices or any other device that incorporates hard-wired and/or program logic to implement relevant operations.

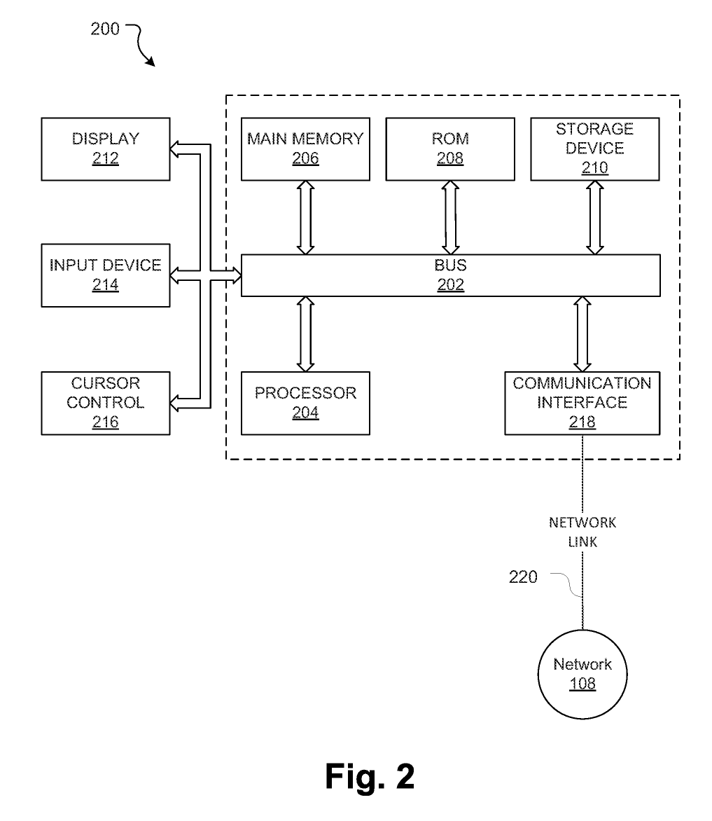

For example, FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions. If the computer system 200 is part of the identity platform 104, the storage device 210 may store database 114.

In case the computer system 200 is the client device 102, it may be coupled via bus 202 to one more output devices such as a display 212 for displaying information to a computer user. Display 212 may, for example, be a cathode ray tube (CRT), a liquid crystal display (LCD), a light emitting diode (LED display), or a touch screen display. An input device 214, including alphanumeric and other keys, may be coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that permits the device to specify positions in a plane. Additional and/or alternative input devices are possible, for example touch screen displays.

According to one embodiment, the methods disclosed herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hardwired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 210. Volatile media includes dynamic memory, such as main memory 206. Common forms of storage media include, for example, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 2504 retrieves and executes the instructions. The instructions received by main memory 206 may optionally be stored on storage device 210 either before or after execution by processor 2504.

Computer system 200 also includes a communication interface 218 coupled to bus 202. Communication interface 218 provides a two-way data communication coupling to a network link 220 that is connected to network 108. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks 108 to other computing systems. For example, if the computing system 200 is part of the identity platform 104, the network link 220 may provide a connection through network 108 to client device 102 or service providers 106.

Computer system 200 can send messages and receive data, including program code, through the network(s), network link 220 and communication interface 218. In the identity platform example, the access module 212 might transmit an access identifier for a through the network 108 and communication interface 218 to the service provider 106A.

The processor 204 of the service provider may execute the received access identifier as it is received, and/or store it in storage device 210, or other non-volatile storage for later execution.

### Group Registration Process Overview

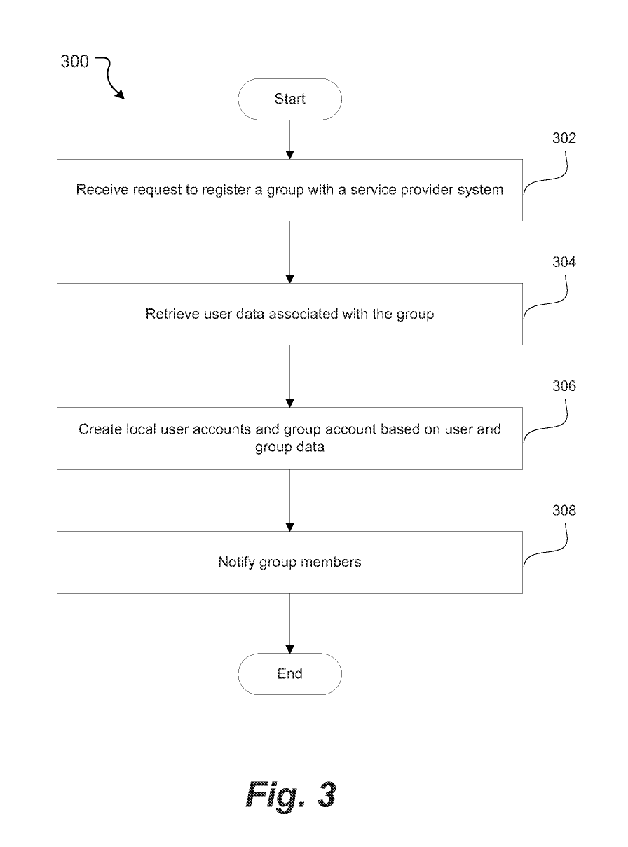

FIG. 3 is a flowchart illustrating a high-level method 300 for creating accounts for a user group with a service provider 106 according to some aspects of the present disclosure.

The method 300 begins at step 302, where an account creation request is received for creating local accounts for a group with a particular service provider (e.g., service provider 106A). The request may be initiated by a member of the group.

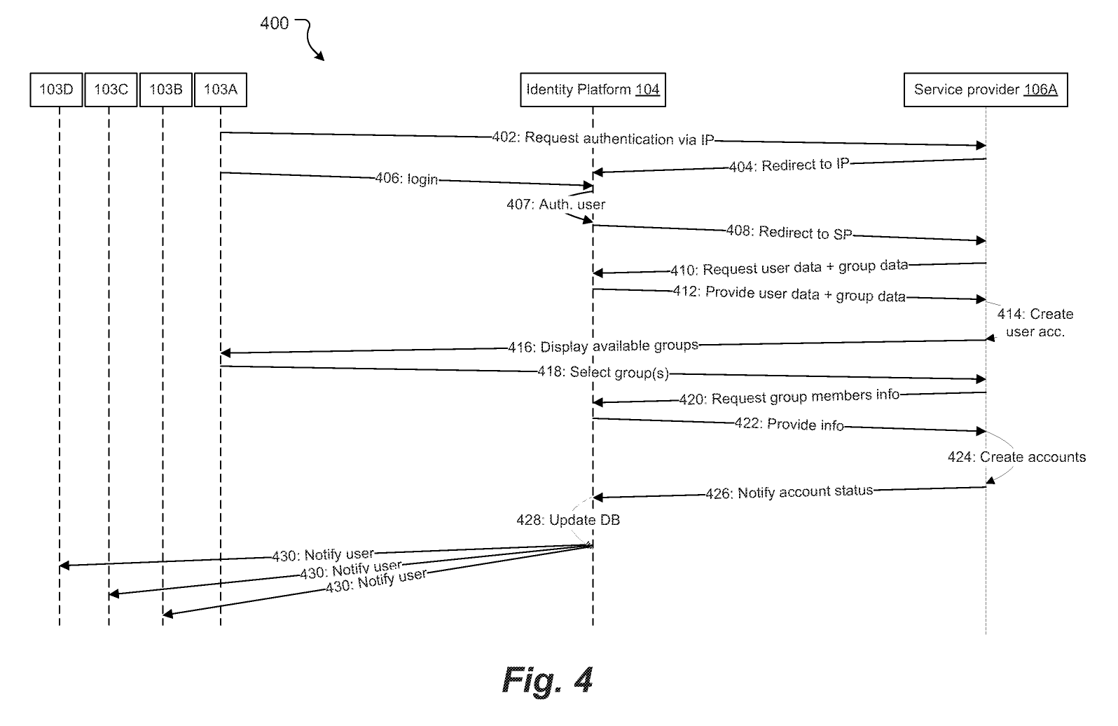

In certain embodiments, the account creation request is received at the service provider 106A. For example, a user may visit application 120A (via the client application 103A) and request the service provider 106A to create accounts for members of the user's group. This embodiment is generally referred to as the ‘pull’ embodiment in this disclosure and is described in detail with reference to FIGS. 4-6.

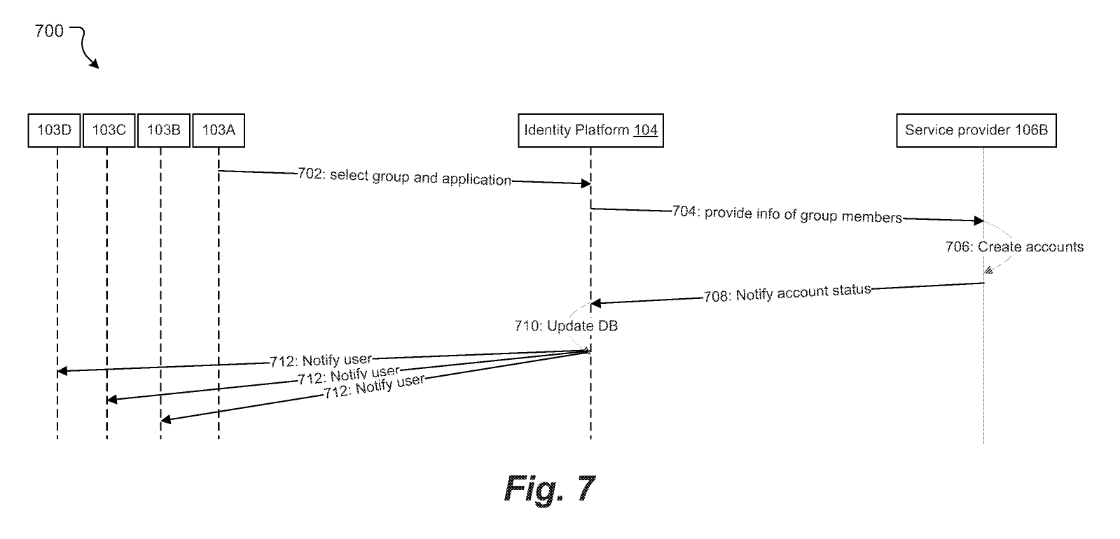

In other embodiments, the account creation request is received at the identity platform 104. In this case, the user visits an application hosted by the identity platform 104 and requests the identity platform 104 to register a selected group with a selected service provider 106A. This embodiment is generally referred to as the ‘push’ embodiment in this disclosure and is described in detail with reference to FIGS. 7-9.

At step 304, user data associated with members of the group is retrieved. In the pull embodiment, the service provider 106A requests the identity platform 104 to provide information about group members (e.g., user names and email addresses). In the push embodiment, the identity platform 104 retrieves information about group members from the database 114 and pushes this information to the service provider 106A.

At step 306, the service provider 106A creates local access accounts for the group members (and in some cases a local group account for the group) based on the received group information. Account creation may include updating the access account data structure (e.g., Table H) and in some cases, the group account data structure (e.g., Tables I and J).

Once local user and/or group accounts are created, users are informed of account creation at step 308. This notification may come from the service provider 106A and/or the identity platform 104. In case an access account existed before step 306 (e.g., in case the user already has an account at service provider as part of a different group), the user may be notified that a new local group account is created for another of the user's groups.

### Pull Embodiment

FIG. 4 is a message-passing diagram illustrating an example method 400 for registering a user group with a particular service provider 106A according to the pull embodiment. In this method 400, a group member visits an application (e.g., 120A) hosted by a particular service provider (e.g., service provider 106A) and requests the service provider 106A to create local service provider accounts for members of a group the user is a part of. In other embodiments, the user may simply request the service provider 106A to create accounts for any team that the user is a member of on the identity platform 104. The request is called an account creation request herein and it does not include any details about group members.

In method 400 it is assumed that the user does not have a local account at the service provider when the user visits the application 120A. Accordingly, this method also shows the steps performed by the various systems to create a local account for the user via the identity platform 104. In case the user already has a local account at the service provider 106A some of the method steps described below may be omitted or altered.

To initiate the process, e.g., user requests to access a homepage of application 120A (via the client application 103A). The client application 103A, in turn, retrieves the homepage from the service provider 106A, and renders it on a display of the user device 102A. Once displayed, the homepage may show an option to ‘sign in with identity platform’ (in the form of an interactive tab, button, or text).

The user selects this option, which causes the client application 103 to transmit a request to the service provider 106A at step 402 to authenticate the user via the identity platform 104.

The service provider 106A receives the authentication request and at step 404 requests the identity platform 104 to authenticate the user. To that end, it redirects the client application 103A to the identity platform 104. Particularly, it redirects the client application 103A to a login page hosted by the identity platform 104.

Next, the identity platform 104 authenticates the user. To do this, the identity platform 104 communicates a user credential request to the client application 103A on the client device 102A. The user credential request essentially requests the user to enter his/her credentials (e.g., username and password) in the identity platform login page. Once entered, these credentials are forwarded from the client application 103A to the identity platform 104 at step 406. The identity platform 104 in turn authenticates the user at step 407 by matching the received credentials with those stored in the database 114 (e.g., in user credential table A). It also updates its database (and particularly the service provider user table F) at this stage. For example, it creates a new record in table F for the user.

Thereafter, at step 408, the identity platform 104 redirects the client application 103 to the service provider application 120A and informs the service provider 106A that the user has been authenticated.

The service provider 106A in turn generates a request for receiving user data and/or group data associated with the user and at step 410 communicates this request to the identity platform 104. The requested user data includes information required by the service provider 106A to create an account for user. The requested group data includes information about one or more groups the user is a part of. This request may, for example, be made via an appropriate API call to the identity platform 104.

After receiving the data request, the identity platform 104 retrieves the requested data from database 114 and at step 412 communicates this to the service provider 106A.

The service provider 106A receives the requested user and/or group data and utilizes the received user data to create an account for the user at step 414. Specifically, the service provider 106A creates a new record in the access account data structure (e.g., table G) with the received user data.

At step 416, the group data received from the identity platform at step 412 is forwarded to the client application 103A. Particularly, the group data may include a group identifier for each group associated with the user. The client application 103A subsequently displays the group data (e.g., in the form of a list of groups the user is a member of) and queries whether the user wishes to register one or more of the displayed group(s) with the service provider 106A. If the user does not select any group at this stage, the client application 103A notifies the service provider 106A of this and the method 400 ends. Alternatively, if the user selects a group for registration, this selection is provided back to the service provider 106A at step 418 in the form of an account creation request.

At step 420, the service provider 106A generates an account information request including a group identifier of the group selected by the user in step 418. In certain embodiments, the account information request may request the identity platform 104 to provide a list of accounts maintained by the identity platform 104 that are associated with the group identifier. In other embodiments, the account information request may request the identity platform 104 to also provide account details in respect of the members of the selected group. This requested information is communicated to the identity platform 104. In certain embodiments, the requested account details include at least a name and email address for each group member. It may also include other personal details, such as age, gender, country, role, etc.

In response to the account information request, the identity platform 104 retrieves the requested account information and forwards it to the service provider 106A at step 422 in the form of an account information response.

At this stage, the service provider 106A utilizes the account details response to create access accounts for group members that are not already registered with the service provider 106A (and a group account, in some cases).

Once this step is completed, the method 400 proceeds to step 426, where the service provider 106A notifies the identity platform 104 of accounts that have been created. The identity platform 104 subsequently (at step 428) updates the service provider data structure (e.g., tables F and G) with information about the new access accounts (and group account) and notifies the group members (at step 430) that they have been registered on the service provider 106A as part of a particular group.

The registered users may also receive notification (e.g., in the form of an email) from the service provider 106A requesting the users to verify their account (e.g., by selecting a URL link embedded in the email). Once verified, users can sign-in/log-on to the application hosted by the service provider 106A using their identity platform credentials.

It will be appreciated that method 400 is described with respect to one embodiment of the present disclosure and method 400 may vary in other embodiments. For example, in certain embodiments, after step 406 (i.e., after the user enters their credentials), the identity platform 104 identifies the user ID associated with the received user credentials and determines whether the user ID is associated with any groups (e.g., by performing a lookup with the user ID in the group data structure). If one or more groups are found, the identity platform 104 displays the identified groups on the client application 103A and asks the user if the user wishes to register any of the identified groups with the service provider 106A. If the user agrees to register one or more groups (e.g., by selecting a group), the identity platform 104 may inform the service provider 106A that the user has requested to create local accounts for a selected group at the service provider, e.g., by forwarding a corresponding group identifier to the service provider at step 408.

In this embodiment, the service provider 106A does not request or receive group data (as described in steps 410-412 above). Instead, the service provider 106A requests information about group members (e.g., via an account information request) at step 412 along with the request for user data. In this case, steps 416-422 are omitted.

Furthermore, in some embodiments, after step 406 (i.e., after the user is authenticated) and before step 408 (i.e., when the client application 103A is redirected to the service provider 106A), the identity platform 104 generates a unique access identifier (e.g., a key, code or token). The access identifier is unique to the service provider 106A and the user (i.e., an access identifier is generated for each service provider and user pair). This generated access identifier is stored in table F and passed to the service provider 106A when the client application 103A is redirected to the service provider at step 409. The service provider 106A stores the access identifier against the user ID in the access account table (e.g., table G). Thereafter, whenever the service provider 106A wishes to access data associated with the user from the identity platform 104, the service provider 106A attaches the access identifier to the access request (e.g., to the account information request and the account details request). The identity platform 104 verifies the access identifier (by comparing with the access identifier stored in table F) before allowing the service provider to access any data or responding to the service provider requests. The use of access identifiers increases security of the transactions between the identity platform and service providers. In one example, the access identifiers may be generated and handled according to an authorization protocol such as the OAuth 2.0 protocol.

### Pull Embodiment: Identity Platform Operation

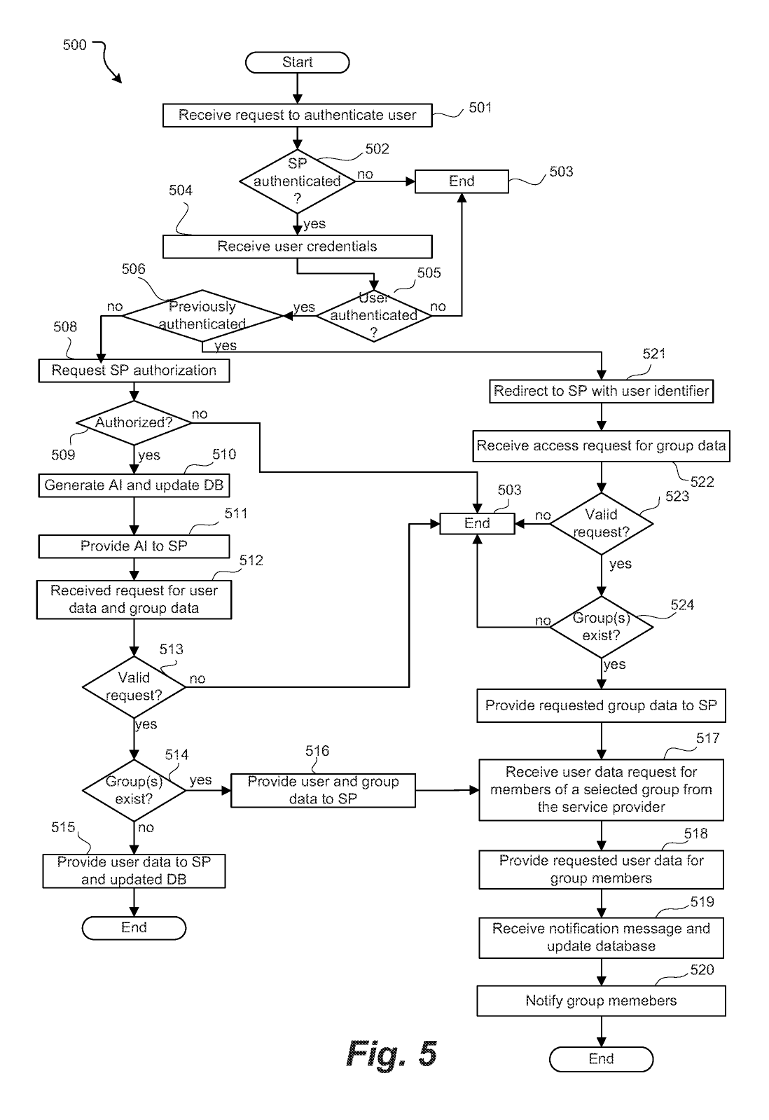

FIG. 5 is a flowchart illustrating the method steps performed by the identity platform 104 to register a group with the service provider 106A. Specifically, this flowchart illustrates the steps performed at the identity platform 104 once it receives a request from the service provider 106A to authenticate the user (i.e., after step 404 of method 400).

At step 501, the identity platform 104 (and in particular the access module 112) receives a request from the service provider 106A to authenticate the user. The authentication request may include information about the service provider 106A. By way of example, this information may include:
a redirect URL of the service provider. The redirect URL is provided to the identity platform 104 so that the identity platform 104 can redirect the user 104A back to the service provider website once the user is authenticated,
a unique service provider key (e.g., a combination of a service provider ID and password or a token). The unique key may be generated when the service provider 106A first registers with the identity platform 104.
a list of permissions requested by the service provider 106A on behalf of the user. The permissions indicate which data the service provider 106A wishes to retrieve from the identity platform 104. In the present disclosure, the service provider 106A may request to access user data and group data associated with the user.

It will be appreciated that this is merely an example. In other embodiments, the service provider 106A may only provide the unique service provider key at this step. In these embodiments, the redirect URL and list of permissions may be forwarded to the identity platform 104 when the service provider 106A first registers with the identity platform 104 and may be stored at the identity platform, e.g., in the service provider data structure (table E).

At step 502, the access module 112 authenticates the service provider 106A. To that end, the access module 112 compares the received service provider key with the corresponding service provider keys stored in the service provider data structure (table E). If the received credentials do not match any stored credentials, the service provider is not authenticated and the method ends at step 503. However, before the method ends, the access module 112 may inform the service provider that the credentials provided for authentication were incorrect.

Alternatively, if the received service provider key matches the corresponding key stored at the identity platform 104, the access module 112 authenticates the service provider 106A and the method proceeds to step 504, where it receives user credentials (e.g., username and password) from the client application 103A.

Next (step 505), the access module 112 authenticates the user. To that end, the received user credentials are matched with stored user credentials (e.g., in table A). If the received credentials do not match the stored credentials, the access module 112 fails to authenticate the user and the method ends at step 503. Before ending the method though, the access module 112 may request the user to re-enter their credentials or create an account with the identity platform 104.

Alternatively, if the user credentials match stored credentials, the user is authenticated and the method proceeds to step 506, where the access module 112 determines whether it has previously authenticated the user for service provider 106A.

If the identity platform 104 had previously authenticated the user for service provider 106A, it assumes that a record would have been created for the user against service provider 106A at that time. Accordingly, at step 506, the access module 112 examines the service provider user data table F to check whether it includes a record for the user against the service provider's unique ID.

If a user record is not found in the service provider data structure, the access module 112 determines that it did not previously authenticate this user for this particular service provider and the method proceeds to step 508 where the identity platform 104 requests the user to authorize the service provider 106A to access user and group data on behalf of the user. To that end, the access module 112 may forward the list of permissions (received from the service provider 106A) to the client application 103 along with a request to authorize or reject the service provider's request to access data on behalf of the user. The user's response to the authorization request is forwarded to the identity platform 104 at the end of step 508.

Based on the user's response to the authorization request, the identity platform (and in particular the access module 112) determines whether the service provider 106 is authorized to access the requested data at step 510. If it is determined that the user did not authorize the service provider 106A, the method ends at step 503. Before ending the method though, the access module 112 may notify the service provider 106A that the user failed to authorize it.

Alternatively, if the access module 112 determines that the user has authorized the service provider 106A, the method proceeds to step 510, where the access module 112 generates a unique access identifier corresponding to the user and service provider pair and updates the database 114 (e.g., by adding a record of the user ID and access identifier against the service provider ID in the service provider data structure). The access identifier may be generated using any known techniques—such as creating a random sequence of numbers and alphabets, hashing the user ID and service provider ID, hashing the user ID, service provider ID and list of permissions.

At step 511, the access module 112 forwards the access identifier to the service provider 106A. It also redirects the client application 103A to the service provider 106A at this step. In certain embodiments, the access module 112 redirects the client application 103A to the service provider 106A using the redirect URL received in step 501 and attaches the access identifier to the redirect URL.

At step 512, the identity platform (and particularly the access module 112) receives an access request from the service provider 106A for user data and group data associated with a user. The access request may include information detailing the type of data requested. For example, it may include data fields such as user name, user email address, user age, user gender, user country, group name and group ID. The access request may also include the access identifier sent to the service provider in the previous step.

At step 513, the access module 112 determines whether the access request is valid. To that end, the access module 112 compares the received access identifier with the access identifier stored against the user ID for the user in the service provider data structure (e.g., table F). If the access identifiers do not match (e.g., because the access identifier has expired), the access module 112 determines that the access request is invalid, and notifies the service provider 106A that the access identifier is invalid and the method ends at step 503. The notification may be in the form of an error message in one example.

However, if the access identifiers match at step 513, the access module 112 determines that the access request is valid and the method proceeds to step 514, where the access module 112 determines whether the user is associated with any groups. To make this determination, the access module 112 performs a lookup of the user ID in the group data structure (e.g. table C).

If the access module 112 fails to identify any groups associated with the user ID at step 514, the method proceeds to step 515 where the access module 112 provides the requested user data to the service provider 106A and notifies the service provider 106A that no groups exist for that particular user.

Alternatively, if as a result of the lookup, the access module 112 identifies one or more groups associated with the user ID at step 514, it retrieves the requested group data (group_name, and group_ID in this example) for each identified group from the group data structure (e.g., table C) and forwards the requested group data along with the requested user data (user name, email address, age, gender and country in this example) to the service provider 106A at step 516.

At step 517, the access module 112 receives an access request from the service provider 106A for user data of members of one or more selected groups. In certain embodiments, the access request includes the access identifier and a list of the requested data fields. For example, if the service provider 106A has requested the name and email addresses of the users in group RED, the access request may include the user name and user email address data fields.

At step 518, the access module 112 retrieves the requested user data and forwards it to the service provider 106A. In certain embodiments, it utilizes the access identifier for retrieving the request data. For example, it performs a lookup in the service provider data structure to determine the permissions associated with the access identifier. If the permissions indicate that the service provider 106A is authorized to access group data, the access module 112 performs a lookup in the groups data structure (e.g., table D) to identify the user IDs associated with the group, and then performs a lookup in the user data structure (e.g., table B) to retrieve the requested user data (user names and email addresses, in this example) associated with the identified user IDs.

At step 519, the access module 112 receives notification from the service provider 106A about account status. In one instance, it receives a list of the user IDs for which local access accounts were created and a list of the user IDs for which local accounts already existed at the service provider 106A. The access module 112 updates the service provider data structures 114 (and particularly tables F and G) with this information. For example, it may create new records in table F for each of the user IDs that are registered with the service provider 106A and create a new record in table G for each of the groups that were registered with the service provider 106A. In some embodiments, the access module 112 leaves the access identifier field blank in table F at this stage and updates this field once the corresponding user verifies the account and accesses the service provider application.

Finally, at step 520, the identity platform 104 notifies the group members of the registration status. The notification may be sent in any suitable form, e.g., as an email, a message, an SMS, or a pop-up in the client application 103. Users that were successfully registered may be informed of the account created with service provider 106A. Users that were not registered, may be informed that members from their group have recently created accounts with the application hosted by the service provider 106A. If these users already have accounts with the service provider 106A and the hosted application is a collaborative application, the identity platform 104 may inform these users about the new group created on the hosted application.

Returning to method step 506, if a record is found, the identity platform 104 determines that it has previously authenticated that particular user for that particular service provider and informs the service provider of this at step 521, e.g., by forwarding information about the user to the service provider. In certain embodiments, this information may be the user's unique user ID or email address. It will be appreciated that if the identity platform had previously authenticated the user for service provider 106A, it assumes that the user had previously authorized the service provider 106A and an access identifier had previously been generated for the user-service provider pair. Accordingly, these steps (i.e. steps 508-510) are skipped.

Retuning to FIG. 5, at step 522, the identity platform 104 (and particularly the access module 112) receives an access request from the service provider 106A for group data associated with the user. This request is similar to the access request received in step 512—that is, it is accompanied with the access identifier, but it does not include a request for user data (as the service provider 106A already has user information from the previous time the identity platform authenticated the user).

At step 523, the access module 112 validates the access request. This step is similar to step 513 and therefore it is not described here again. If the request is not validated, the service provider 106A is notified that the access identifier is not correct and the method ends at step 503.

Alternatively, if the request is validated, the method proceeds to step 524, where the access module 112 determines whether the user is associated with any groups. This step is similar to step 514 and therefore is not described here again. If the access module 112 determines that the user is not associated with any groups, the identity platform 104 notifies the service provider 106A that no group data could be found and the method ends at step 503. Alternatively, if the access module 112 determines that the user is associated with one or more groups, it forwards the requested group data (group name and group ID in this example) to the service prodder at step 525.

It shall be appreciated that in some embodiments, the identity platform 104 does not request the user to authorize the service provider at step 508. This step may be skipped, for example, if the service provider 106A has not provided a list of permissions (in this case the identity platform may permit the service provider 106A to access a default set of data), or the user has previously agreed to share their user and group data with any service provider 106 the user wishes to register with.

### Pull Embodiment: Service Provider Operation

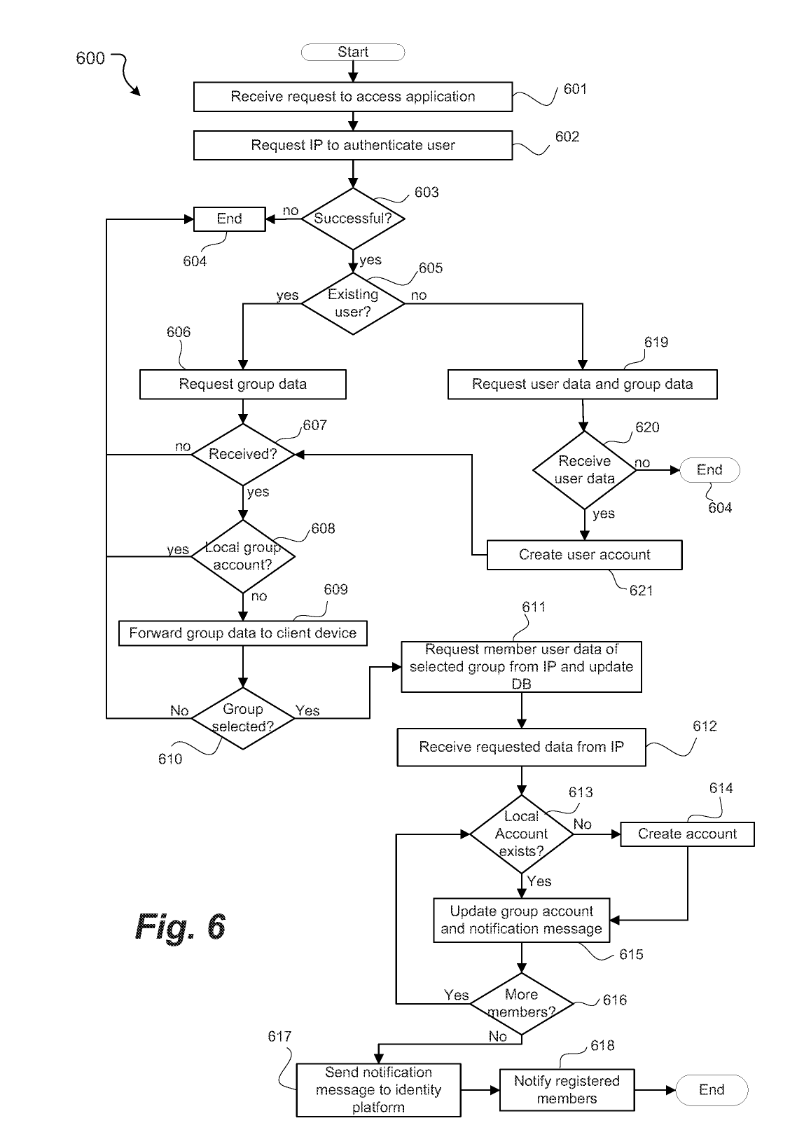

FIG. 6 is a flowchart illustrating the method steps performed by the service provider 106A to create local access accounts for a group of users. It is assumed that the application 120A hosted by the service provider 106A is a collaborative application that allows users to form groups and collaborate within their groups and therefore the service provider also creates a group account in method 600.

The method begins at step 601, where the service provider 106A receives a request from a client application 103A to access an application (e.g., application 120A) hosted by the service provider 106A. Particularly, the service provider 106A receives a request to sign in a user using the identity platform 104.

At step 602, the service provider 106A requests the identity platform 104 to authenticate the user. As described previously, the service provider 106A forwards service provider details (e.g., credentials, redirect URL and list of requested permissions) to the identity platform in the request. Moreover, it redirects the client application 103A on the client device 102A to the identity platform 104 for authentication and particularly to a login page of the identity platform 104 at this step. The redirection may be done through a redirect URL.

The service provider (and particularly the account creation module 116A) receives communication from the identity platform 104 indicating an outcome of the user authentication and at step 603 it determines whether the authentication was successful or not. In some cases, the account creation module 116A may receive an error message. For example, if the service provider failed authentication (at step 502), the user failed authentication (at step 504), or the user failed to authorize the service provider 106A (at step 509).

Accordingly, at step 603, if the received communication is an error message, the account creation module 116A determines that the authentication was unsuccessful, and ends method 600 at step 604.

Alternatively, if the received communication is not an error message, the account creation module 116A determines that authentication was successful and the method proceeds to step 605, where it determines whether a local account exists for the user. This is generally determined based on the content of the communication received from the identity platform 104 in the previous step.

If the communication indicates that the user was previously authenticated by the identity platform and includes e.g., a user identifier, the service provider 106 examines the local access account data structure (table H) to check if a record corresponding to the user identifier exists. If it does, the service provider determines that a local account exists for the user.

Alternatively, if the communication indicates that the user was not previously authenticated by the identity platform 104 and includes e.g., an access identifier, the service provider determines that a local account does not exist for the user.

If at step 605 it is determined that a local account exists, the method proceeds to step 606, where the service provider (and in particular the account creation module 116) requests the identity platform 104 to forward group data associated with the user. To that end, the service provider 106A retrieves the access identifier associated with the user from the access account data structure (e.g., table H) and generates an access request. As described previously, with respect to FIG. 5, the access request includes the access identifier and a list of requested data fields.

At step 607, the account creation module 116A determines whether the requested group data is received from the identity platform 104. In one example, the group data includes at least an identifier, such as group ID, of each group associated with the user. If the access request were invalid or if the user is not part of any groups, the identity platform 104 may inform the account creation module 116 that the request is invalid or that no group data exists. In this case, the service provider determines that group data is not received, and the method ends at step 604.

Alternatively, if the account creation module 116 receives the requested group data, the method proceeds to step 608, where it determines whether local group account(s) exist for the group(s) associated with the received group data. To that end, the account creation module 116A compares the received group identifier(s) with the unique group identifiers stored in the group account data structure.

If each of the received group IDs matches a stored group ID, it is determined that local account(s) already exist for the corresponding group(s) and the group data associated with the corresponding group ID(s) is discarded and the method ends at step 604.

Alternatively, if at least one received group ID does not match any stored group IDs, the account creation module 116 determines that at least one corresponding local group account does not exist and the method proceeds to step 609 where it forwards the corresponding group data to the client application 103A. The client application 103A in turn may display the received group data in the form of a list of groups on a display of the client device 102A. In some embodiments, the client application 103 asks the user whether the user wishes to register one or more of the displayed group(s) with the application hosted by service provider 106A.

At step 610, the service provider 106A determines whether an account creation request is received or not. If the user decided to register one or more groups, the client application 103A forwards an account creation request to the service provider 106A. Alternatively, if the user decided against registering any group, the client application 103A informs the service provider 106A that the user does not wish to register any groups (e.g., via an error message).

If an error message is received from the client application at this step, the service provider 106A determines that no groups were selected and the method ends at step 604.

Alternatively, if at step 610, the service provider 106A receives a request to register one or more groups, it determines that an account creation request is received and the method proceeds to step 611, where the account creation module 116A requests the identity platform 104 to forward user data corresponding to the members of the selected group(s). As described with respect to FIG. 5, this data request includes the access identifier and an identifier for each of the selected groups (e.g., group name and/or group ID). The data request may also include the fields for which the service provider 106A requires data. This is optional. If the fields are not explicitly added in the data request, the identity platform may provide all the data for the corresponding group members that the service provider is allowed to access.

For each selected group, the account creation module 116A also creates a group record in the account database 118 (and in particular in the group account table H) at this step.

At step 612, the service provider 106A receives the requested user data from the identity platform 104. As described previously, the user data includes identification information for each member in the selected group(s).

At step 613, for each received user record, a determination is made whether a local access account already exists. To that end, the account creation module 116A compares a unique user identifier (e.g., user ID or email address) with the corresponding identifiers stored in the account database 118.

If no match is found at step 613, it determines that the member was not previously registered and the method proceeds to step 614 where an access account is created for user. Specifically, at step 614, the account creation module 116A updates the account database 118 with a new record for the user. The record includes information about the user received from the identity platform. The access identifier field may be left empty at this stage and may be updated when the user verifies the account or signs in for the first time.

Once the access account record is created, the method proceeds to step 615 where the account creation module 116A updates the corresponding group account record (created at step 611) to include the user ID of the user and updates a notification message to indicate that an account has been created for that particular user.

Alternatively, if a match is found at step 613, the service provider 106A determines that the user is already registered and the method proceeds directly to step 615 where the service provider 106A updates the corresponding group account record to include the user ID of the user and updates the notification message to indicate that an account has not been created for that particular user.

At step 616, the account creation module 116 determines whether it has processed all the user data received at step 612. If it hasn't, the method returns to step 613 where the account creation module 116A determines whether a local access account exists for the next user. Steps 613-616 are repeated until all the received user data is processed. Thereafter, the method proceeds to step 617 where the notification message is forwarded to the identity platform 104 and notifications are sent to each of the users registered at step 618 to inform them that their account creation is complete. Users who already had access accounts, but were added to the new group account are also notified that they have been added to a new group created on the service provider 106A. The notifications may be in any suitable form, e.g., email, message, or SMS.

Returning to step 605, if the account creation module 116A determines that a local access account does not exist, it generates an account information request requests the identity platform 104 to provide user data as well as group data at step 619.

At step 620, the service provider 106A checks whether user data is received. If user data is not received (e.g., because the access identifier was not validated at step 513), the method end at step 604. Alternatively, if the service provider 106A determines that user data is received at 620, the method proceeds to step 621, where a local access account is created. To that end, the service provider 106A may create a new record in the access account data structure (e.g., in table H). Thereafter, the method proceeds to step 607.

It will be appreciated that in method 600, it is assumed that application 120A is a collaborative application that allows users to form groups and collaborate within their groups. Therefore, in method 600 the service provider also creates a group account. If the application 120A does not support group accounts, a group account is not created at step 611 or updated at step 615 in method 600.

In method 600, it is assumed that the user is associated with multiple groups and therefore a list of user groups is forwarded to the client device 102A for display on a user interface at step 609. The user subsequently selects one or more groups he/she wishes to register with the service provider 106A. In other embodiments, the user may be associated with a single group and the user may request that members of that group be registered with the service provider at step 602. In that case, the client device 102A communicates an account creation request to the service provider 106A (e.g., by selecting a group registration button on the user interface). The service provider 106A in turn identifies the group associated with the user (e.g., based on the received account creation request or by requesting the identity platform 104 to forward a group identifier associated with the user). Thereafter, the service provider 106 generates and forwards an account information request to the identity platform 104 that includes an identifier of the identified group. In response to the account information request the identity platform may retrieve and communicate account information for the group and/or account details in respect of the members of the group in the form of an account information response.

Furthermore, as described herein, the account information response includes account details of members of a group. In other embodiments, the account details may be requested for and received at a later stage, e.g., between steps 613 and 614 (i.e., after determining whether a local account exists and prior to creating the local account). To this end, the service provider 106A may generate and communicate an account details request to the identity platform and receive an account details response from the identity platform that includes account details for one or more group members.

Furthermore, in the methods described with respect to FIGS. 4-6, permission is not sought from the group members to provide their user data to the service provider 106A. In certain cases, this may be because users authorize the identity platform to forward their user data (or a few data fields from their user data) to service providers for creating group accounts when users first register with the identity platform 104.

In other embodiments, user permission may be sought from group members before their data is forwarded to the service provider 106A (e.g., before steps 422, 517, and 612). For example, the identity platform may inform group members that a particular group member has requested a service provider 106 to create local access accounts for all members of the group and may request the users to authorize this. In this case, the identity platform may wait for the group members to authorize the request before forwarding group member user details to the service provider.

### Push Embodiment

FIG. 7 is a message-passing diagram illustrating an example method 700 for registering a group with a particular service provider (e.g., service provider 106B) according to the push embodiments. In this method 700, a group member visits an application hosted by the identity platform 104 (e.g., a group application) and logs in (e.g., by providing his/her login credentials). The group application retrieves data pertinent to the user and sends this data to the client application 103A to render a user interface depicting information customized for that particular user. For example, the user interface may display group information about the groups the user is a member of. The group information may include for example, group name, group avatar, group members, recent group activity, applications and services utilized by the group, and so on. In addition to group information, the user interface may also depict information about applications hosted by service providers 106 in environment 100. Specifically, the user interface may display information about service providers 106 in environment 100 that have registered with the identity platform 104, allowing the two systems to communicate with each other using, e.g., a set of agreed upon API calls and functions.

At step 702, the client application 103A forwards an account creation request to the identity platform 104 to register a particular group associated with the user with an application hosted by service provider 106B. Particularly, the user may select a particular group and a particular application from their homepage for registration and the client application 103 may in turn forward this selection to the identity platform 104 in the form of an account creation request.

At step 704, the identity platform 104 retrieves user data for the group members of the selected group from the database 114 and forwards this information to the selected service provider 106B.

At step 706, the service provider 106B creates accounts for new users based on the group information received at step 704. This account creation process is similar to the account creation process described with respect to FIG. 4.

Once accounts are created, the service provider 106B notifies the identity platform 104 that accounts are created for the group members at step 708. The identity database 104 in turn updates database 114 (in particular the service provider data structure) and notifies the group members that they have been registered to use the selected application at the service provider 106B.

### Push Embodiment: Identity Platform Operation

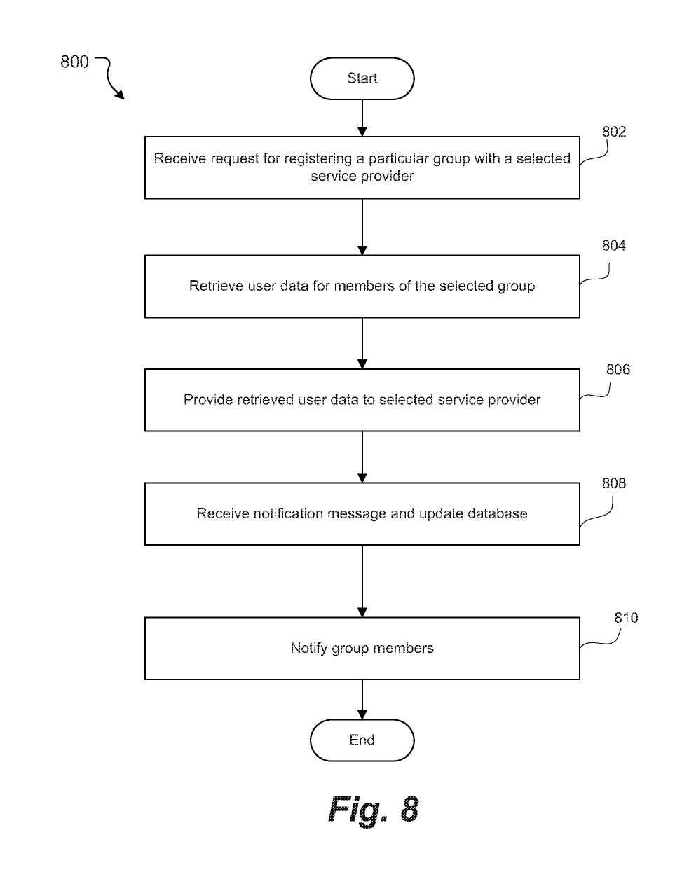

FIG. 8 is a flowchart 800 illustrating the method steps performed by the identity platform 104 to register a group according to the push embodiment.

At step 802, the identity platform 104 receives an account creation request from the client device 102A to register a selected group with a selected service provider (e.g., 106B). The account creation request includes a group identifier that uniquely identifies the group, e.g., a group name, or group ID, and a service provider identifier that uniquely identifies the service provider, e.g., service provider ID. The account creation request may also include a command requesting the identity platform 104 to register the group with the service provider.

At step 804, the access module 112 retrieves user data for members in the selected group. To this end, the access module 112 processes the received account creation request and performs a lookup with the group identifier in the group data structure (e.g., table) to identify the selected group and retrieve the user IDs of the group members. Once the user IDs of group members is retrieved, the access module 112 performs a lookup with the user IDs to retrieve associated user data from the user data table B.

At step 806, the retrieved user data is forwarded to the service provider 106B via an appropriate API call.

Steps 808 and 810 are concerned with receiving a notification from the service provider and notifying users of account registration. These steps are similar to steps 519 and 520 of method 500 respectively and will not be described again.

### Push Embodiment: Service Provider Operation

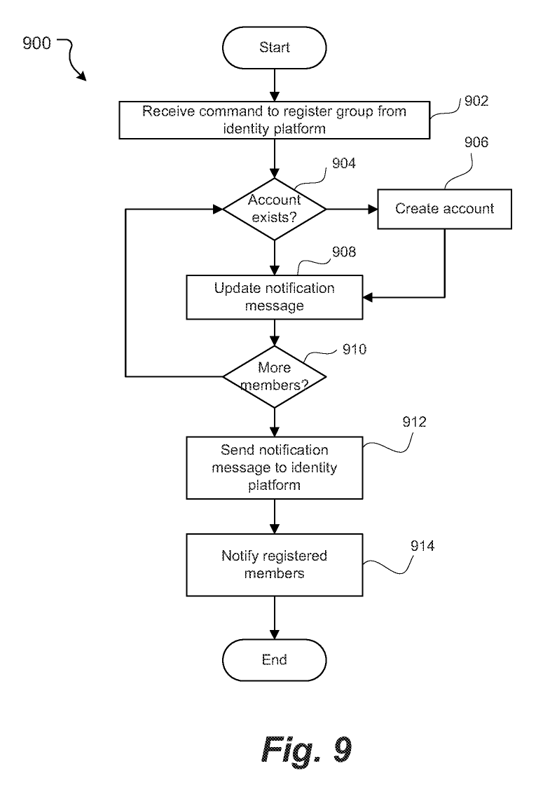

FIG. 9 is a flowchart illustrating the steps performed by the service provider 106B to register a group of users according to the push embodiment.

At step 902, the service provider 106B (and in particular the account creation module 116B) receives a command to register a group from the identity platform 104. The command includes group information (e.g., a group name and group identifier) and user information (e.g., user names and email addresses for members of the group).

Steps 904-914 of method 900 are similar to steps 613-618 of method 600, respectively and will not be described again.

### Update Process

Occasionally, a group maintained by the identity platform 104 may be updated—e.g., if a new user is added to a group or an existing member is removed from the group. When this happens, the account management module 110 updates the corresponding group account data structure.

If a corresponding group account is also maintained on a service provider database 118, in certain embodiments, the identity platform 104 notifies the corresponding service provider so that the service provider can update its group account accordingly.

This is particularly useful for service providers that host collaborative applications as the service provider can automatically create an account for a new user and/or add the new user to an existing group account (if a new user is added to the identity platform group account) or remove a user from an existing group account (if a user is removed from an identity platform group account).

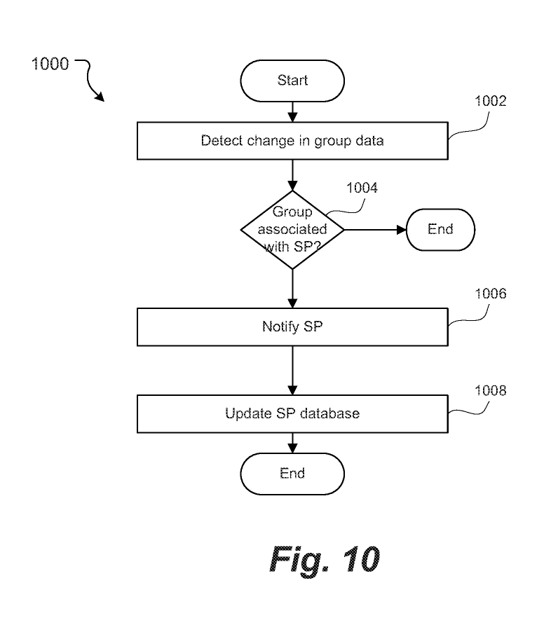

FIG. 10 illustrates an example notification method 1000 according to some aspects of the present disclosure. The method begins at step 1002 where one or more changes are detected in a group account. For example, the identity platform 104 may detect a change in the group member data table (table D)—i.e., a new record may be added for a particular group ID or an existing record for a particular group ID may be deleted. Similarly, a change may be detected in the group data structure (table C, e.g., if an existing group is deleted).

Next, the identity platform 104 determines whether the changed group data is associated with a service provider. This check may be made by performing a lookup in the service provider data structure (and more particularly in service provider group data structure table G). If it is determined that the group is not associated with a service provider, the method ends at step 1006.

Alternatively, if it is determined that the group is associated with a service provider 106, the identity platform 104 sends a notification to the identified service provider at step 1008. The notification may include information about the type of change (i.e., new user added or removed, or an existing group deleted) along with an identifier of the updated group.

If the service provider 106 wishes to act on the update, it may subsequently update its database (at step 1010). For example, if the detected change was removal of one or more members of a group, the service provider may delete the corresponding user IDs from the group member data structure (table J). Alternatively, if the detected change was addition of one or more members to a group, the service provider may request the identity platform 104 to provide details about the new group members (e.g., user data) so that the service provider can create new access accounts and update the group member database.

In certain embodiments, the identity platform 104 may detect changes in group data in real time and provide updates in real time to service providers. Alternatively, the identity platform may examine the group data structure periodically to identify changes in group data.

Furthermore, in some embodiments, the identity platform 104 may detect changes in group data and push notifications to the corresponding service providers. Alternatively, service providers may pull notifications from the identity platform 104 periodically.

It shall be appreciated that before forwarding user data of new group members to the service provider 106, the identity platform 104 may obtain permission from the new group members. This may be done when users first sign on with the identity platform 104 or just before the identity platform 104 communicates user details to the service provider 106.

Further examples of specific feature combinations taught within the present disclosure are set out in the following numbered clauses:

Clause 1. A computer-implemented method, the method comprising: receiving, by an identity platform from a client device, an account creation request, the account creation request being a request for a service provider system independent of the identity platform to create a plurality of service provider accounts at the service provider system, the account creation request not including account details in respect of individual service provider accounts to be created; responsive to receiving the account creation request from the client device: identifying, by the identity platform, a group and the service provider system associated with the account creation request; identifying, by the identity platform, account information, the account information identifying a plurality of identity platform accounts maintained by the identity platform and associated with the identified group; determining, by the identity platform, whether the identified service provider is authorized to receive the account information; upon determining that the identified service provider system is authorized to receive the account information, communicating, by the identity platform, the account information with a group account creation request to the identified service provider system, the group account creation request being a request for the identified service provider to create service provider accounts corresponding to the identity platform accounts at the service provider system; receiving, at the identity platform, notification from the service provider system of creation of one or more local service provider accounts corresponding to one or more of the identity platform accounts identified in the account information; and for a given identity platform account corresponding to a created local service provider account, communicating, by the identity platform, a notification to a client device associated with the given identity platform account.

Clause 2. The computer-implemented method of clause 1, wherein the account creation request received from the client device at the identity platform includes one or more of a service provider identifier and a group identifier, the group identifier corresponding to the group.

Clause 3. The computer-implemented method of clause 1, further comprising: prior to receiving the account creation request from the client device: receiving, by the identity platform, an authentication request from the client device to authenticate a user of the client device; communicating, by the identity platform, a user credential request to the client device; validating, by the identity platform, user credentials received from the client device in response to the user credential request, the validating based on a comparison of the received user credentials with user credentials maintained by the identity platform for the user; and in response to a positive validation, providing, by the identity platform, to the client device, access to a service hosted by the identity platform.

Clause 4. The computer-implemented method of clause 1, further comprising: in response to receiving, at the identity platform, the notification from the service provider of creation of the one or more local service provider accounts, updating a service provider database at the identity platform to include account details of the one or more local service provider accounts.

Clause 5. The computer-implemented method of clause 1 further comprising: detecting, at the identity platform, addition of a new identity platform account to the group maintained by the identity platform; in response to detecting addition of the new identity platform account: determining, by the identity platform, whether one or more local service provider accounts are created for the group corresponding to the new identity platform account at one or more service provider systems; upon determining that one or more local service provider accounts are created for the group corresponding to the new identity platform account at one or more service provider systems, generating, by the identity platform, an update message identifying the new identity platform account and the corresponding group, and communicating, by the identity platform, the update message to the one or more service provider systems; and receiving, by the identity platform, notification from a given service provider system responsive to creation of a corresponding local service provider account for the new identity platform account at the given service provider system.

Clause 6. A computer implemented method comprising: receiving, at a service provider system, from an identity platform independent of the service provider system: account information identifying a plurality of identity platform accounts maintained by the identity platform and associated with the group; a group account creation request to create local service provider accounts corresponding to the identity platform accounts identified in the account information; for a given identity platform account identified in the account information: obtaining by the service provider system, account details in respect of the given identity platform account; creating, by the service provider system, a local service provider account, the local service provider account created using the obtained account details in respect of the given identity platform account; and communicating, by the service provider system, a notification to the identity platform that the local service provider account is created for the corresponding identity platform account.

Clause 7. The computer-implemented method of clause 6, further comprising: determining, by the service provider system, whether a local service provider account exists for a corresponding identity platform account; in response to determining that a local service provider account for the corresponding identity platform account does not exist: requesting account details for the corresponding identity platform account from the identity platform; receiving by the service provider system from the identity platform, account details for the requested identity platform account; and creating, by the service provider, a local service provider account corresponding to the identity platform account based on the account details received from the identity platform.

Clause 8. The computer-implemented method of clause 7, wherein the account details for a given identity platform account comprises at least one of a user name, a user email address, or a unique key associated with the member.

Clause 9. The computing-implemented method of clause 6, further comprising: creating, by the service provider system, a local service provider group account at the service provider system, the local service provider group account corresponding to an identity platform group account maintained by the identity platform.

Clause 10. The computer-implemented method of clause 6, further comprising: receiving, at the service provider system, an update message from the identity platform identifying a new identity platform account added at the identity platform to a group maintained by the service provider system; determining, by the service provider system, whether a local service provider account exists for the new identity platform account received in the update message; upon determining that a local account does not exist for the new identity platform account, obtaining by the service provider system, account details of the new identity platform account, and creating, by the service provider system, a local service provider account corresponding to the new identity platform account using the obtained account details in respect of the new identity platform account.

Clause 11. A system for automatically creating one or more user accounts at a service provider, the system comprising a processor and a memory storing instructions, which when executed by the processor cause the system to: receive from a client device, an account creation request, the account creation request being a request for a service provider system independent of the identity platform to create a plurality of service provider accounts at the service provider system, the account creation request not including account details in respect of individual service provider accounts to be created; responsive to receiving the account creation request from the client device: identify a group and the service provider system associated with the account creation request; identify account information, the account information identifying a plurality of identity platform accounts maintained by the identity platform and associated with the identified group; determine whether the identified service provider is authorized to receive the account information; upon determining that the identified service provider system is authorized to receive the account information, communicate the account information and a group account creation request to the identified service provider system, the group account creation request being a request for the identified service provider to create service provider accounts corresponding to the identity platform accounts at the service provider system; receive notification from the service provider system of creation of one or more local service provider accounts corresponding to one or more of the identity platform accounts identified in the account information; and for a given identity platform account corresponding to a created local service provider account, communicate a notification to a client device associated with the given identity platform account.

Clause 12. The system of clause 11, wherein the account creation request received from the client device at the identity platform includes one or more of a service provider identifier and a group identifier, the group identifier corresponding to the group.

Clause 13. The system of clause 11, wherein the instructions when executed by the processor further cause the system to: prior to receiving the account creation request from the client device: receive an authentication request from the client device to authenticate a user of the client device; communicate a user credential request to the client device; validate user credentials received from the client device in response to the user credential request, the validating based on a comparison of the received user credentials with user credentials maintained by the identity platform for the user; and in response to a positive validation, provide access to a service hosted by the identity platform.

Clause 14. The system of clause 11, wherein the instructions when executed by the processor further cause the system to: in response to receiving the notification from the service provider of creation of the one or more local service provider accounts, update a service provider database at the identity platform to include account details of the one or more local service provider accounts.

Clause 15. The system of clause 11 wherein the instructions when executed by the processor further cause the system to: detect addition of a new identity platform account to the group maintained by the identity platform; in response to detecting addition of the new identity platform account: determine whether one or more local service provider accounts are created for the group corresponding to the new identity platform account at one or more service provider systems; upon determining that one or more local service provider accounts are created for the group corresponding to the new identity platform account at one or more service provider systems, generate an update message identifying the new identity platform account and the corresponding group, and communicate the update message to the one or more service provider systems; and receive notification from a given service provider system responsive to creation of a corresponding local service provider account for the new identity platform account at the given service provider system.

Clause 16. A system for automatically creating one or more user accounts at a service provider, the system comprising a processor and a memory storing instructions, which when executed by the processor cause the system to: receive from an identity platform independent of the service provider system: account information identifying a plurality of identity platform accounts maintained by the identity platform and associated with the group; a group account creation request to create local service provider accounts corresponding to the identity platform accounts identified in the account information; and for a given identity platform account identified in the account information: obtain account details in respect of the given identity platform account; and create a local service provider account, the local service provider account created using the obtained account details in respect of the given identity platform account.

Clause 17. The system of clause 16, wherein the instructions when executed by the processor further cause the system to: determine whether a local service provider account exists for a corresponding identity platform account; in response to determining that a local service provider account for the corresponding identity platform account does not exist: request account details for the corresponding identity platform account from the identity platform; receive from the identity platform, account details for the requested identity platform account; and create a local service provider account corresponding to the identity platform account based on the account details received from the identity platform.

Clause 18. The system of clause 16, wherein the account details for a given identity platform account comprises at least one of a user name, a user email address, or a unique key associated with the member.

Clause 19. The system of clause 16, wherein the instructions when executed by the processor further cause the system to: create a local service provider group account at the service provider system, the local service provider group account corresponding to an identity platform group account maintained by the identity platform.

Clause 20. The system of clause 19, wherein the instructions when executed by the processor further cause the system to: receive an update message from the identity platform identifying a new identity platform account added at the identity platform to a group maintained by the service provider system; determine whether a local service provider account exists for the new identity platform account received in the update message; upon determining that a local account does not exist for the new identity platform account, obtain account details of the new identity platform account, and create a local service provider account corresponding to the new identity platform account using the obtained account details in respect of the new identity platform account.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including”, “includes”, “comprising”, “comprises”, “comprised” and the like) are intended to be inclusive and are not intended to exclude further features, components, integers or steps.

Various features of the disclosure have been described using flowcharts. The functionality/processing of a given flowchart step could potentially be performed in various different ways and by various different systems or system modules. Furthermore, a given flowchart step could be divided into multiple steps and/or multiple flowchart steps could be combined into a single step. Furthermore, the order of the steps can be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

1. A computer implemented method comprising:
receiving, by a service provider system from a client device, an account creation request, the account creation request being a request for the service provider system to create a plurality of service provider accounts at the service provider system, the account creation request not including account details in respect of individual service provider accounts to be created;
responsive to receiving the account creation request from the client device:
identifying, by the service provider system, a group associated with the account creation request;
generating, by the service provider system, an account information request, the account information request comprising a group identifier identifying the group associated with the account creation request;
communicating, by the service provider system, the account information request to an identity platform, the identity platform being independent of the service provider system;
receiving, by the service provider system from the identity platform, an account information response, the account information response identifying a plurality of identity platform accounts maintained by the identity platform and associated with the group identifier; and
for a given identity platform account identified in the account information response:
obtaining, by the service provider system, account details in respect of the given identity platform account;
creating, by the service provider system, a local service provider account corresponding to the given identity platform account, the local service provider account created using the obtained account details in respect of the given identity platform account.

2. The computer-implemented method of claim 1, wherein prior to communicating the account information request to the identity platform the method further comprises:
redirecting, by the service provider system, the client device from the service provider system to the identity platform for authentication; and
receiving, at the service provider system from the identity platform, notification that authentication by the identity platform was successful.

3. The computer-implemented method of claim 1, further comprising:
identifying, by the service provider system, a user of the client device;
determining, by the service provider system, whether a local service provider account for the user exists;
in response to determining that a local service provider account for the user does not exist:
requesting account details in respect of the user from the identity platform; receiving, by the service provider system from the identity platform, account details in respect of the user; and
creating, by the service provider, a local service provider account for the user based on the account details for the user received from the identity platform.

4. The computer-implemented method of claim 1, wherein responsive to receiving the account creation request from the client device the method further comprises:
determining, by the service provider system, whether the group associated with the account creation request is already registered with the service provider system by comparing the group identifier with one or more group identifiers stored locally by the service provider system; and
wherein the account information request is generated by the service provider system and communicated to the identity platform in response to determining that the group associated with the account creation request is not already registered with the service provider system.

5. The computer-implemented method of claim 1, for a given identity platform account identified in the account information response the method further comprises:
determining, by the service provider, whether a local service provider account corresponding to the given identity platform account access account already exists; and
wherein obtaining account details in respect of the given identity platform account and creating a local service provider account corresponding to the given identity platform account is performed in response to determining that a local service provider account corresponding to the given identity platform account does not already exist.

6. The computer-implemented method of claim 1, wherein obtaining account details in respect of a given identity platform account comprises:
generating, by the service provider system, an account details request identifying at least the given identity platform account;
communicating, by the service provider system, the account details request to the identity platform; and
receiving, by the service provider system from the identity platform, an account details response comprising account details for at least the given identity platform account.

7. The computer-implemented method of claim 6, wherein the account details request includes identifiers for the identity platform accounts identified in the account information response.

8. The computer-implemented method of claim 6, wherein generating the account details request comprises:
identifying, by the service provider system, one or more new accounts, a new account being an identity platform account identified in the account information response for which no corresponding local service provider account exists;
generating the account details request to include identifiers in respect of the new accounts identified.

9. The computer-implemented method of claim 1, wherein identifying the group associated with the account creation request comprises:
identifying, by the service provider system, a user of the client device;
requesting, by the service provider system, the identity platform to provide information in respect of one or more groups associated with the user at the identity platform;
receiving, by the service provider system from the identity platform, group information comprising a group identifier for each group associated with the user at the identity platform;
causing, by the service provider system, information in respect of each associated group to be displayed on the client device;
receiving, at the service provider system, selection information indicating a selection of a particular group from the one or more groups; and
identifying, by the service provider system, the group associated with the account creation request based on the particular group indicated by the selection information.

10. A computer-implemented method comprising:
receiving, at an identity platform an account information request from a service provider system, the service provider system independent of the identity platform, the account information request comprising a group identifier identifying a group maintained by the identity platform;
identifying, by the identity platform, a group corresponding to the group identifier;
generating, by the identity platform, an account information response identifying a plurality of identity platform accounts maintained by the identity platform and associated with the identified group;
determining, by the identity platform, whether the service provider system is authorized to request account information;
communicating, by the identity platform, the account information response to the service provider system in response to determining that the service provider system is authorized to request the account information;
receiving, at the identity platform, notification from the service provider of creation of one or more local service provider accounts, the or each local service provider account corresponding to an identity platform account identified in the account information response; and
for a given identity platform account corresponding to a created local service provider account, communicating, by the identity platform, a notification to a client device associated with the given identity platform account.

11. The computer-implemented method of claim 10, further comprising:
receiving, at the identity platform, a user authentication request from the service provider system, the authentication request comprising a unique service provider key and received at the identity platform when a client device associated with a first user is redirected from the service provider system to the identity platform;
determining, by the identity platform, whether the service provider is authorized to make the authentication request by comparing the received unique service provider key with one or more service provider keys maintained by the identity platform;
in response to determining that the service provider is authorized, communicating a user credential request to the client device of the first user;
validating, by the identity platform, user credentials received from the client device of the first user in response to the user credential request, the validating based on a comparison of the received user credentials with user credentials maintained by the identity platform for the first user; and
in response to a positive validation, notifying the service provider system that the first user is authenticated.

12. The computer-implemented method of claim 11 further comprising:
determining, by the identity platform, whether the first user was previously authenticated for the service provider system;
in response to determining that the first user was previously authenticated for the service provider system, redirecting the client device of the first user back to the service provider system from the identity platform along with a user identifier associated with the first user; and
in response to determining that the first user was not previously authenticated for the service provider system:
generating a unique access identifier associated with the first user and the service provider system; and
redirecting the client device of the first user back to the service provider system from the identity platform along with the unique access identifier.

13. The computer-implemented method of claim 10, wherein the one or more user identifiers include at least one of a user name, a user email address, or a unique key associated with the user.

14. The computer-implemented method of claim 10, wherein for the or each identity platform account corresponding to a created local service provider account the method further comprises:
recording, by the identity platform, that the identify platform account has a corresponding account at the service provider.

15. A system comprising a processor and a memory storing instructions, which when executed by the processor cause the system to:
receive from a client device, an account creation request, the account creation request being a request for the service provider system to create a plurality of service provider accounts at the service provider system, the account creation request not including account details in respect of individual service provider accounts to be created;
responsive to receiving the account creation request from the client device:
identify a group associated with the account creation request;
generate an account information request, the account information request comprising a group identifier identifying the group associated with the account creation request;
communicate the account information request to an identity platform, the identity platform being independent of the service provider system;
receive, from the identity platform, an account information response, the account information response identifying a plurality of identity platform accounts maintained by the identity platform and associated with the group identifier; and
for a given identity platform account identified in the account information response:
obtain account details in respect of the given identity platform account;
create a local service provider account corresponding to the given identity platform account, the local service provider account created using the obtained account details in respect of the given identity platform account.

16. The system of claim 15, wherein the instructions when executed by the processor further cause the system to:
prior to communicating the account information request to the identity platform:
redirect the client device from the service provider system to the identity platform for authentication; and
receive from the identity platform, notification that authentication by the identity platform was successful.

17. The system of claim 15, wherein the instructions when executed by the processor further cause the system to:
for a given identity platform account identified in the account information response:
determine whether a local service provider account corresponding to the given identity platform account already exists; and
obtain account details in respect of the given identity platform account and create the local service provider account corresponding to the given identity platform account in response to determining that a local service provider account corresponding to the given identity platform account does not already exist.

18. A system comprising a processor and a memory storing instructions, which when executed by the processor cause the system to:
receive an account information request from a service provider system, the service provider system independent of the identity platform, the account information request comprising a group identifier identifying a group maintained by the identity platform;
identify a group corresponding to the group identifier;
generate an account information response identifying a plurality of identity platform accounts maintained by the identity platform and associated with the identified group;
determine whether the service provider system is authorized to request account information;
communicate the account information response to the service provider system in response to determining that the service provider system is authorized to request the account information;
receive notification from the service provider of creation of one or more local service provider accounts, the or each local service provider account corresponding to an identity platform account identified in the account information response; and
for a given identity platform account corresponding to a created local service provider account, communicate a notification to a client device associated with the given identity platform account.

19. The system of claim 18, wherein the instructions when executed by the processor further cause the system to:
receive an authentication request from the service provider system, the authentication request comprising a unique service provider key and received at the identity platform when a client device associated with a first user is redirected from the service provider system to the identity platform by the service provider system;
determine whether the service provider is authorized to make the authentication request by comparing the received service provider key with one or more service provider keys maintained by the identity platform;
in response to determining that the service provider is authorized, communicate a user credential request to the client device of the first user;
validate user credentials received from the client device of the first user in response to the user credential request, the validating based on a comparison of the received user credentials with user credentials maintained by the identity platform for the first user; and
in response to a positive validation, notify the service provider system that the first user is authenticated.

20. The system of claim 19, wherein the instructions when executed by the processor further cause the system to:
determine whether the first user was previously authenticated for the service provider system;
in response to determining that the first user was previously authenticated for the service provider system, redirect the client device of the first user back to the service provider system from the identity platform along with a user identifier associated with the first user; and
in response to determining that the first user was not previously authenticated for the service provider system:
generate a unique access identifier associated with the first user and the service provider system; and
redirect the client device of the first user back to the service provider system from the identity platform along with the unique access identifier.
